(19) United States
(12) Patent Application Publication
(10) Pub. No.: US 2013/0024786 A1
(43) Pub. Date: Jan. 24, 2013

(54) MULTI-USER UNIVERSAL MULTI-CONVERSATION PLATFORM (MUMCP) METHOD AND SYSTEM

(71) Applicant: Sandeep Dayal, Long Grove, IL (US)

(72) Inventor: Sandeep Dayal, Long Grove, IL (US)

(21) Appl. No.: 13/555,995

(22) Filed: Jul. 23, 2012

Related U.S. Application Data
(60) Provisional application No. 61/510,257, filed on Jul. 21, 2011.

(51) Int. Cl. G06F 3/01

(52) U.S. Cl. 715/753

(57) ABSTRACT

Provided is a multi-user, universal multi conversation computer platform (MUMCP), comprising a computer system accessible via one or more networks by a plurality of different types of electronic devices and systems and a computer program product hosted on the computer system, and executable to provide a graphical user interface (GUI) via a user device, the GUI comprising a plurality of computer screens delivering a set of user-based functions. The functions can include enabling a user to define a plurality of conversation categories, enabling the user to define different user identities for use when conversing in different conversation categories, enabling the user to define different conversation groups of users for each conversation category, organizing the conversation categories in independent display regions on a conversation page, displaying conversation activity into respective independent display regions, and enabling the user to communicate with other users within a conversation category using a user defined identity.

### CROSS-REFERENCE TO RELATED APPLICATIONS

This application claims the benefit, under 35 U.S.C. §119, to U. S. Provisional Patent Application No. 61/510,257 entitled MULTI-USER UNIVERSAL MULTI-CONVERSATION PLATFORM (MUMCP) METHOD, filed on Jul. 21, 2011, the disclosure of which is incorporated herein in its entirety by reference.

### FIELD OF INTEREST

The inventive concepts relate to systems and methods useful in the field of online social interactions and messaging, and more particularly to systems and methods for facilitating online conversations that allow users to collaborate virtually to exchange ideas, share information, coordinate activities and solve problems, using computer devices, such as laptops, tablet computers, smart phones and other electronic devices, capable of connecting to the World Wide Web or Internet.

### BACKGROUND

People are increasingly using the Internet/online/electronic channels to communicate. They may do so through email, SMS, Twitter or social networks (e.g. Facebook and Google+). However, each of these platforms has limitations which make it inconvenient or impractical for the more involved, everyday conversations amongst consumers with each other or with businesses, and amongst business users themselves and with consumers. The more involved conversations are those that involve several participants, with known or unknown identities, that entail multiple exchanges on related topics amongst them synchronously or asynchronously.

Examples of the more involved everyday conversations may include a set of friends critiquing a movie, a family planning an extended family vacation, a set of people having a political debate, a company conducting a focus group, etc. There is no single platform that allows a user to have many different types of the more involved conversations simultaneously.

In other cases, the features provided by the platform are insufficient or inconvenient for having certain types of conversational exchanges. For example, consider a set of six college going friends that want to discuss the latest “Transformers” movie. Over the summer, they are in different cities and may see the movie on different days. None of the currently existing online platforms are designed to allow these six friends to have a conversation like exchange to critique the movie. While they may do so on email, their responses will be mixed in with other emails and/or comments from other friends about different topics, compromising the conversational stream. Likewise, while the discussion may have different topics, such as “Quality of Acting”, “Quality of Storyline” and “Quality of Directing”, those comments often get mixed together in a social network based exchange.

Email is designed for message exchanges with everyone. A typical email stream consists of messages arranged in the order of receipt. This mixes up all messages related to a given conversation with many other messages related to other conversations as well as topics within a message. Further, since email is a repository for all messages, substantive conversations are mixed up with the barrage of less important emails and advertisements, leading to great difficulty for the user in organizing multi-participant communications around conversational themes or subjects, with sub-topics of discussion.

On the other hand, social networks, like Facebook and Google+, are designed as platforms that allow groups of people to connect with each and share among themselves items, such as, pictures, videos and their status (where they are, what they are doing, etc.) in the form of a merged “newsfeed”, but not to have involved conversations with multiple topics, communications with sub-sets of participants, etc. in a single conversational stream. Consequently, it is difficult to organize multiple conversations with distinct audiences and topics on these platforms in an organized, natural and intuitive manner. Further, the constant flood of status updates, in the form of a newsfeed, not organized by subject matter or topics, is increasingly seen as an irritant by many consumers who feel overwhelmed by the quantity of information that flows constantly to them as various connected members of the group update their status independently.

Further, email and social networks are not designed to allow different people to play the role of a moderator, facilitator or arbiter as is required in many real life discussions. While those features are sometimes available in a forum setting, they are not easily available to small groups that form around everyday conversations, such as the six friends mentioned earlier discussing a movie they had seen.

Likewise, social networks, emails and forums do not allow participants to charge each other for their participation or their opinion as is the case in real-life Focus Groups or advisory discussions. While some expert websites charge an access fee or sell reports for a fee, it is inconvenient for small groups to set up such arrangements. For example, a palm-reader that wants to set up a conversation with her clients, receive scanned images of their palms and charge a fee for each session, needs to set up a special site to do so, and cannot simply use email or a social network.

To engage in these different types of conversations, users must go to many different sites, often having to register at each and fragmenting their interactions all over the web.

Another problem on forum type interaction platforms is that users can post comments anonymously, without consequence, which sometimes leads to the quality of conversations deteriorating when someone makes obnoxious remarks, causing others to respond in kind with similarly obnoxious comments or to leave the forum.

Separately, advertisements (Ads) on websites present a problem for users of those websites, as clicking on ads re-directs the users to interact with the ad source or be redirected to other websites. This interrupts the users' review of and engagement with the original content and presents a distraction from their original activities.

### SUMMARY

The present invention is a multi-user, universal, multi-conversation platform (MUMCP) system and method. It uses computers, the Internet and other electronic devices (e.g. cell phones, smart phones, mobile tablet computers, and other devices capable of linking up with the Internet) to provide a conversation platform on which a user can conveniently set up multiple conversations, each with a distinct audience or set of participants and multiple topics.

Further, the format in which the conversations are presented and the underlying logic is designed to present a unique interface that corresponds to real-life communication cues that the average person is accustomed to, e.g. a “newspaper format”, “email invites”, “conversation and topic segregation”, “bubble-up of active conversation”, etc.

In accordance with one aspect of the present disclosure, provided is a multi-user, universal multi conversation computer platform, comprising: a computer system accessible via one or more networks by a plurality of different types of electronic devices and systems; and a computer program product hosted on the computer system, and executable to provide a graphical user interface (GUI) via a user device. The GUI comprising a plurality of computer screens delivering a set of user-based functions, including: enabling a user to define a plurality of conversation categories; enabling the user to define different user identities for use when conversing in different conversation categories; enabling the user to define different conversation groups of users for each conversation category; organizing the conversation categories in independent display regions on a conversation page; displaying conversation activity into respective independent display regions; and enabling the user to communicate with other users within a conversation category using a user defined identity.

In various embodiments, the system can include computer modules with the ability to pay users to participate in or observe a conversation or collect a fee from users to participate in a given conversation.

In various embodiments, the system can further comprise computer modules for “Click-To-Mail” functionality for Advertising.

In various embodiments, the system can further comprise computer modules for “Click-To-Mail” functionality for Snippets, calendar, to-do, bulletins, wherein any one or more of these items can be highlighted just like a snippet and the “IMail” button pressed to forward the item to the users email in a single click.

In various embodiments, the one or more networks can include the Internet and World Wide Web.

In various embodiments, the electronic devices can include one or more of cell phone, iPad, personal digital assistant, lap top, personal computer, and the like.

In various embodiments, the electronic devices can include one or more of advertising systems, payment systems, and social networking systems.

In various embodiments, the independent display regions can be presented as user-selectable tabbed regions.

In various embodiments, the set of user-based functions can include: enabling the user to initiate a new conversation.

In various embodiments, the set of user-based functions can include: enabling the user to modify an existing conversation.

In various embodiments, the set of user-based functions can include: enabling the user to follow a conversation.

In various embodiments, the set of user-based functions can include: enabling the user's communication within the conversation category to include one or more of text, video, audio, file transfer, and link transfer.

In various embodiments, the user can define different types of users within a selected conversation group.

In various embodiments, the different types can have different levels of trust with respect to the user.

In various embodiments, the set of user-based functions can include: enabling the user to personalize communications with third party ad providers via the GUI.

In various embodiments, the set of user-based functions can include: wherein the ad personalization is a function of a user profile and preferences.

In various embodiments, the set of user-based functions can include: enabling the generation and presentation of a personalized ad page, via which personalized ads are organized for the user by the platform.

In various embodiments, the GUI includes a “click-to-page” function that enables a user to graphically select an ad, and in response the platform transfers the selected ad to the user's personalized ad page.

In various embodiments, the GUI includes a “click-to-mail” function that enables a user to graphically select an ad, and in response the platform causes an e-mail containing ad information to be sent to the user's e-mail account.

In various embodiments, the set of user-based functions can include: determining if there are “snippets” of a conversation followed by the user that are unread, within a conversation category; prioritizing the conversations according to conversation criteria; presenting the high priority conversations and snippets at the top of a display region, above lower priority conversations and snippets, on the conversation page.

In accordance with various aspects of the invention, the above system can be implemented to carry out a method comprising the steps performed above by the computer modules.

### BRIEF DESCRIPTION OF THE DRAWINGS

The present invention will become more apparent in view of the attached drawings and accompanying detailed description. The embodiments depicted therein are provided by way of example, not by way of limitation, wherein like reference numerals refer to the same or similar elements. The drawings are not necessarily to scale, emphasis instead being placed upon illustrating aspects of the invention. In the drawings:

FIG. 1A is an embodiment of a conversation hub page presented on a display by a multi-user, universal multi-conversation platform (MUMCP) system, in accordance with aspects of the present invention;

FIG. 1B is another embodiment of a conversation hub page presented on a display by the MUMCP system, in accordance with aspects of the present invention;

FIG. 2A is an embodiment of a conversation page presented on a display by the MUMCP system in response to a user selection of a conversation subject (or simply conversation) on the page of FIG. 1A, in accordance with aspects of the present invention;

FIG. 2B is another embodiment of a conversation page presented on a display by the MUMCP system in response to a user selection of a conversation subject (or simply conversation) on the page of FIG. 1B, in accordance with aspects of the present invention;

FIG. 3A is an embodiment of a reply page presented on a display by the MUMCP system in response to a user selection of the “reply” button on the page of FIG. 2A, in accordance with aspects of the present invention;

FIG. 3B is another embodiment of a reply page presented on a display by the MUMCP system in response to a user selection of a reply on the page of FIG. 2B, in accordance with aspects of the present invention;

FIG. 4 is an embodiment of a notional diagram demonstrating conversation groupings and entities implemented by the MUMCP system, in accordance with aspects of the present invention;

FIG. 5A is an embodiment of a functional flow diagram demonstrating click-to-mail and click-to-page functions implemented by the MUMCP system, in accordance with aspects of the present invention;

FIG. 5B is an embodiment of a functional flow diagram demonstrating use of the click-to-mail function implemented by the MUMCP, in accordance with aspects of the present invention;

FIG. 6 is an embodiment of an ads page presented on a display by the MUMCP, in accordance with aspects of the present invention;

FIG. 7 is a diagram of an architecture comprising an embodiment of a MUMCP system, in accordance with aspects of the present invention;

FIG. 8A is a flow diagram of an embodiment of a method of conversation setup using the MUMCP system, in accordance with aspects of the present invention;

FIG. 8B is an embodiment of a display screen useful for explaining an embodiment of a method of conversation setup using the MUMCP system of FIG. 7, in accordance with aspects of the present invention;

FIG. 8C is an embodiment of display screens of a different Settings pages useful for a method of conversation setup using the MUMCP system of FIG. 7, in accordance with aspects of the present invention;

FIG. 9 is a flow diagram of an embodiment of a method of conversation participation using the MUMCP system, in accordance with aspects of the present invention;

FIG. 10 is a flow diagram of an embodiment of a method of bubble-up, newspaper sort conversation using the MUMCP system, in accordance with aspects of the present invention; and

FIG. 11 is a flow diagram of an embodiment of a method of click-to-mail and click-to page ads flow using the MUMCP system, in accordance with aspects of the present invention.

### DETAILED DESCRIPTION OF PREFERRED EMBODIMENTS

Various exemplary embodiments will be described more fully hereinafter with reference to the accompanying drawings, in which some exemplary embodiments are shown. The present inventive concept may, however, be embodied in many different forms and should not be construed as limited to the exemplary embodiments set forth herein.

It will be understood that, although the terms first, second, etc. are be used herein to describe various elements, these elements should not be limited by these terms. These terms are used to distinguish one element from another, but not to imply a required sequence of elements. For example, a first element can be termed a second element, and, similarly, a second element can be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a,” “an” and “the” are intended to include the plural fauns as well, unless the context clearly indicates otherwise. It will be further understood that the terms “comprises,” “comprising,” “includes” and/or “including,” when used herein, specify the presence of stated features, steps, operations, elements, and/or components, but do not preclude the presence or addition of one or more other features, steps, operations, elements, components, and/or groups thereof.

A multi-user, universal multi-conversation platform (MUMCP) is a computer-based system that contains uniquely configured software and/or firmware in conjunction with computer hardware (e.g., processors coupled to computer memory) that collectively serve as a hub for a number of substantive conversations that any person is having at a given point and in a given period of their personal or business lives. By focusing on providing the features needed to effectively conduct only these select conversations, the MUMCP is able to simplify the presentation of these messages and allow for greater flexibility in conducting them. Therefore, the MUMCP distinguishes itself from existing user interfaces, such as an email system that can be used as a repository of all messages that a user receives and sends and thus provides a different interface, but is otherwise extremely limited. Likewise, a social network is usually a platform for connecting comprehensively to all personal or business friends/colleagues and relations of a user and for sharing items updates with them electronically, but does not specifically lend itself to conversing or collaborating to exchange ideas, solve problems and coordinate activities, and hence also a very different, often ad hoc and cluttered interface that is unsuitable for conversation oriented exchanges.

In various embodiments, the MUMCP enables a method for allowing a user to engage in multiple online conversations, each with multiple topics and a distinct set of participants through one or more electronic devices and media. The MUMCP display interfaces are intuitively organized to conform to natural or real-life conversational interactions amongst groups and streamlined to better manage advertising interruptions.

Preferably, the MUMCP is designed to mimic visual and communication cues that the average person is familiar with in their real life. In one version, the conversations are organized in the familiar newspaper format such that every “news story” in the newspaper is a conversation. Hence, the MUMCP provides a personal newspaper with news stories that are the personal conversations of the user.

In the MUMCP, each conversation can have a subject, topic, snippets, participants, observers, moderator(s), convenor(s) and arbiter(s). Further, multiple conversations can be grouped in a user defined category. In various embodiments, each observer or participant can have multiple identities. Every conversation in its entirety may be referred to as a “story.” The discussion threads for each story can center around hot topics, rather than a status of connections. Additionally, conversations may have other tools such as calendars, to-do lists, polls and cover pages controlled by the convener or jointly by the participants.

Every conversation may fall into a user-defined, broad conversation category, such as, “family”, “friends”, “personal health”, “work” or “hobbies” signifying the general nature and content of stories in that category. Within each category, for example “Family”, a user may have multiple conversations on different subjects. For example, a daughter's career choice, a cousin's request for a personal loan, the extended family's vacation plans, and so on. Each conversation can have a unique set of participants, for example, the participants in the “Extended Family Vacation” conversation may be different from the participants in “the cousins request for a loan” conversation, even though both fall in the broader category of family conversations. Each conversation may further be divided into different user defined topics. For example, the topics within the “Family Vacation” conversation may be “Who to invite?”, “Where to go?” and “What to budget?”

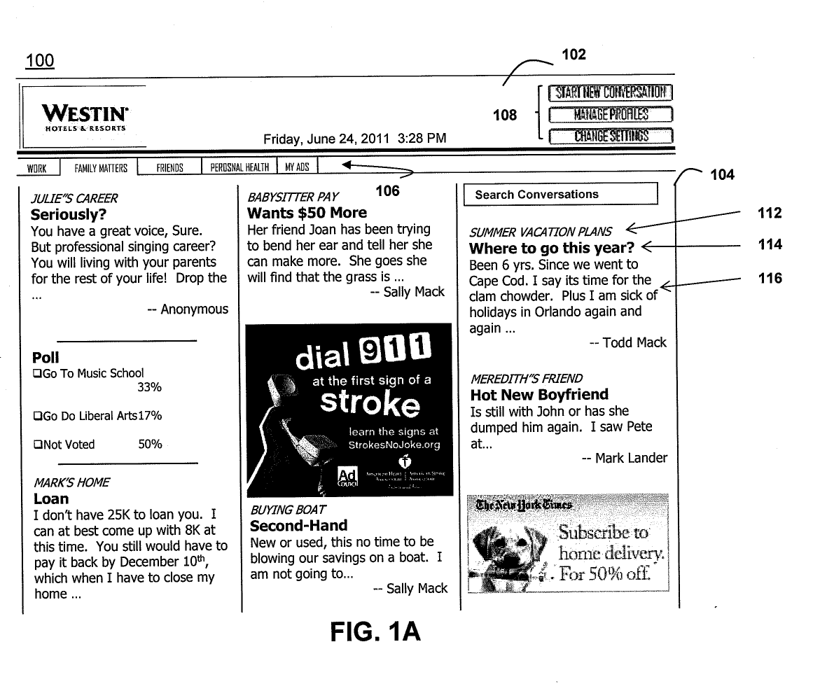

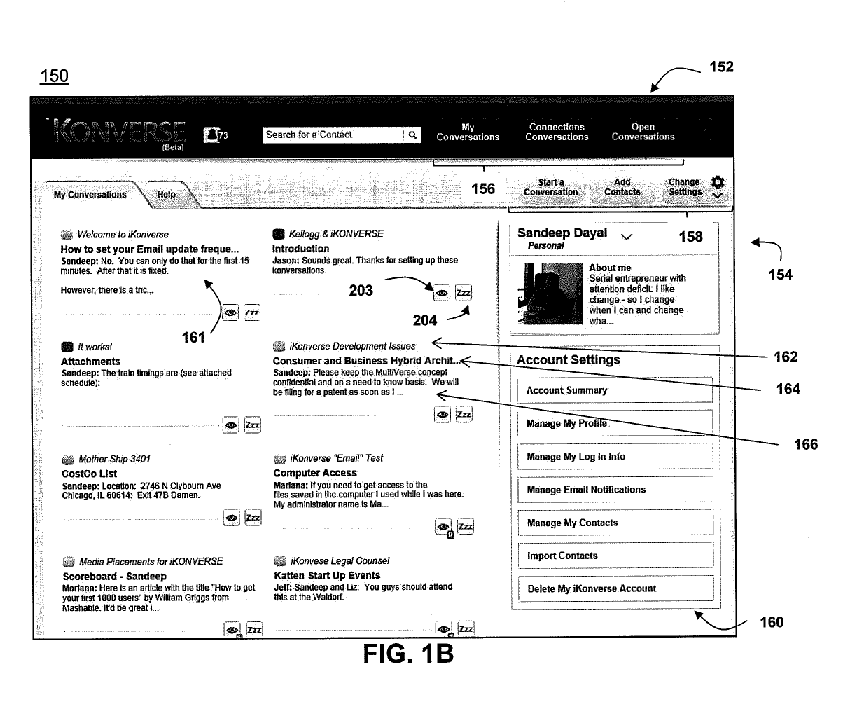

FIG. 1A is an embodiment of a conversation hub page 100 presented on a display by the MUMCP, in accordance with aspects of the present invention. This page 100 can serve as an opening (or home) page for a user of the MUMCP.

The conversation hub page 100, in this embodiment, is formatted as a newspaper-like page with a header region 102 and a main region 104 with multiple columns. Header region 102 includes several user selectable buttons 108. Buttons 108, in this embodiment include a “START NEW CONVERSATION” button. Selecting this button enables a user to start a new conversation. The new conversation would be started under one of the conversation categories, e.g., it could be started under the selected conversation category tab. For the new conversation, the user would be prompted for a conversation subject and topic, and would define a set of conversation participants. The participants can be selected from the user's contacts, which can be stored in the system. The contacts could be imported from an email program (e.g., Outlook) and/or a social media site (e.g., LinkedIn or Facebook).

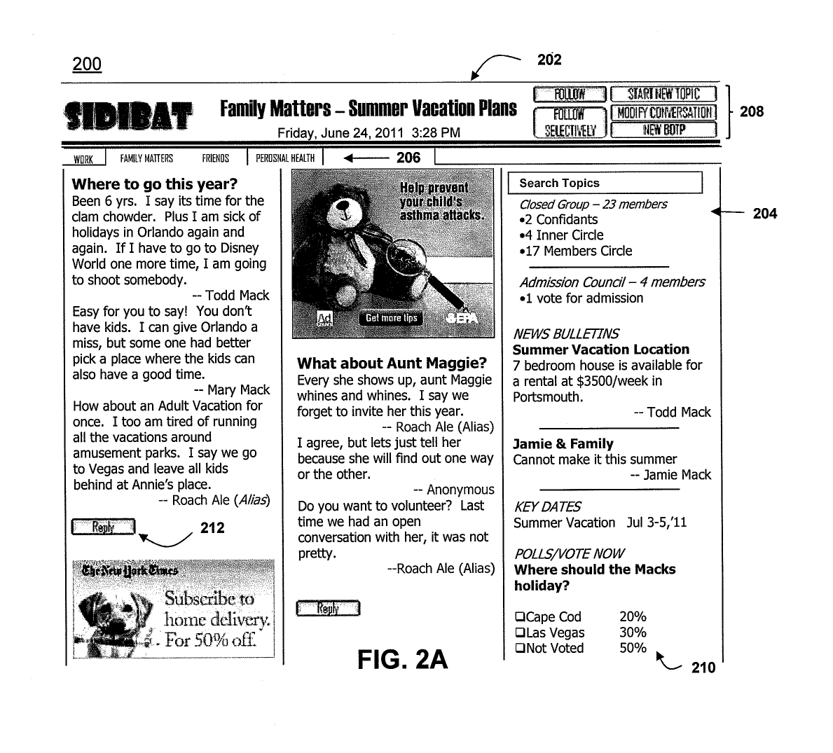

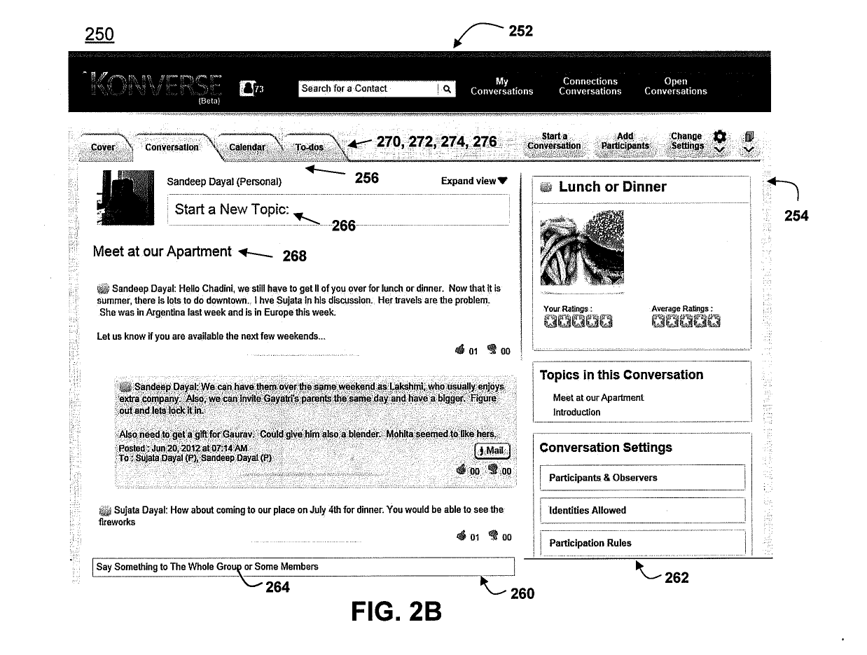

The main region 104 has multiple sections that are selectable via labeled tabs 106. Each tab is a broad conversation category. In the page of FIG. 1A, the tab “FAMILY MATTERS” has been selected, and is therefore viewable. Every conversation within a category appears as a summary story with its subject 112, topic 114, and content (or snippet) 116. As each conversation has multiple topics and snippets, only a prioritized snippet is viewed in the summary. For example, the prioritized snippet may be one that was the most recently received or unread by the user. In FIG. 1A, a conversation subject is “SUMMER VACATION PLANS,” which has a topic “Where to go this year?” that is shown with a snippet from a user Todd Mack. While every conversation in this example is amongst family, there is possibly a separate audience for each conversation. Clicking on a conversation (e.g., snippet) brings the user deeper into the conversation, as is shown in FIG. 2A.

FIG. 1B is another embodiment of a conversation hub page 150 presented on a display by the MUMCP, in accordance with aspects of the present invention. As with the embodiment of FIG. 1A, the page includes a header region 152 and a main region 154. The layout in FIG. 1B differs somewhat from that of FIG. 1A in that header region 152 includes a set of conversation category buttons or tabs 156: My Conversations, Connections Conversations, and Open Conversations. In this view, the My Conversations tab has been selected, which causes the My Conversations page to be displayed, with multiple columns. In this embodiment, the right most column 160 includes information about the logged in user, Sandeep Dayal, with several available links for managing and editing user data (e.g., “Manage My Profile”). As in FIG. 1A, every conversation within a category appears as a summary story with its subject 162, topic 164, and content (or snippet) 166. As each conversation has multiple topics and snippets, only a prioritized snippet is viewed in the summary. For example, the prioritized snippet may be one that was the most recently received or unread by the user 161. In FIG. 1B, a conversation subject is “iKonverse Development Issues,” which has a topic “Consumer and Business Archit . . . ” that is shown with a snippet from Sandeep.

Beneath the header 152 there is provided user selectable buttons 158. Buttons 158, in this embodiment include a “Start a Conversation” button. Selecting this button enables a user to start a new conversation. The new conversation could be started under one of the conversation categories, e.g., it could be started under the selected conversation category tab, or under a new conversation category. For the new conversation, the user would be prompted for a conversation subject (and later in the conversation page, for a topic), and would define a set of conversation participants. The participants can be selected from the user's contacts, which can be stored in the system. The Add Contacts button enables a use to add (or invite) new contacts to his contact list to his contact list by typing their email or searching for them on the platform, The Change Setting button enables a user to tailor his account settings as shown in the options listed under “Account Settings” on the right panel 160. The settings thus made by the user apply to the users account and all conversation that he starts or is participating in.

By clicking on a particular story or conversation in the conversation hub pages of FIGS. 1A and 1B, the system takes the user to a “Conversation Page,” shown in FIGS. 2A and 2B. In this page, the user may view the conversations in more detail and respond to snippets added by participants or add its own snippets. On the conversation page, each topic is separated out in different sections and columns.

FIG. 2A is an embodiment of a conversation page 200 presented on a display by the MUMCP in response to a user selection of a conversation topic on the page of FIG. 1A, in accordance with aspects of the present invention. Conversations are automatically organized around topics—a new stream starts if the Topic is changed. The conversation page 200 has the same basic layout of the conversation hub page of FIG. 1A. There is a header region 202 and a main region 204. As in FIG. 1A, main region 204 has multiple sections that are selectable via labeled tabs 206. Each tab is a broad conversation category. People can converse as themselves, an alias, or anonymously.

In the header region 202, there is a set of buttons 208. Buttons 208 include a Follow button enables the user to follow a conversation. This button is used when a user finds or is invited to a conversation of interest and wants to be aware of updates in it. By de-selecting the button thus a user may ignore a conversation that he is invited to or is a participant in. A Follow Selectively button enables the user to follow updates made by the convener only or another subset of the overall participants. This button is used when in a large audience conversation only certain participants are of interest to the user. A Start New Topic button enables the user to start a new topic under the selected conversation subject. A Modify Conversation button enables the user to change various settings in the conversation such as his identities, privacy levels, etc. This button is used when the user wants to tailor his participation in the conversation and use only specific identities, or allow only certain types of participation. And New BDTP button enables the user to use collaboration tools 210. This button is used when the user wants to add various collaboration or productivity tools to the conversation, such as a calendar, to-do list, polls, news bulletins or a cover page.

In this case, the conversation subject “SUMMER VACATION PLANS” was selected from main region 102 of conversation hub page 100 of FIG. 1A. As a result, conversation topics under this subject are displayed in the main region 202 of the conversation page 200, e.g., the conversation topic “Where to go this year?”. Another topic that is also part of this conversation is also shown, i.e., “What about Aunt Maggie?”.

On a conversation page, a space or column can be reserved for adding or responding to collaboration or productivity tools such as “News Bulletins”, “Key Dates/Calendar”, “To-Do's” and “Polls”, together referred to as “BDTPs”. The BDTPs can also bubble up to the top based on criteria, such as how recent the snippet is, whether read or not by user, level of urgency, etc. The right column 210, in this embodiment, includes the BDTPs as a variety of subsections of information relevant to the conversation subject. For example, News Bulletins and Polls and Key Dates are conveniently available. A poll can be generated by the user for this conversation and conversation participants can vote in the poll. The news bulletins can also include content by conversation participants. The BDTPs are different from the conversation snippets in that they can be co-edited or acted on by multiple participants. In contrast, a conversation snippet can only be changed by the person that wrote it or a moderator. The information in column 210 for Closed Groups and Admission Council represent a description of the membership of the group, according to one embodiment. Messages may be sent to all members, confidants only or an inner circle of a group.

FIG. 2B is another embodiment of a conversation page 250 presented on a display by the MUMCP in response to a user selection of an eye icon 203 for a conversation on the conversation hub page 150 of FIG. 1B, in accordance with aspects of the present invention. The conversation page 250 has the same basic layout of the conversation hub page of FIG. 2A. There is a header region 252 and a main region 254. Header region 252 includes a set of conversation category buttons or tabs 256, which are the same as buttons 252 in FIG. 1B: My Conversations, Connections Conversations, and Open Conversations. Buttons 158 described above are also shown here as buttons 258.

Main region 254 has multiple sections that are selectable via labeled tabs 256. In this embodiment a Conversation tab 272 is selected and shows content provided by a plurality of users (i.e., conversation participants) on the conversation topic, in primary frame 260. A secondary frame 262 is provided in this embodiment that presents information related to the conversation. For example, there is a portion entitle Topics in this Conversation, which, as is evident, provides a user-selectable list of topics in the current conversation.

Conversations are automatically organized around topics. A Start a New Topic field 266 is provided to enable a participant to enter the name of a new topic, with a comment, to add the topic to the conversation. In the preferred embodiment, the highest priority (e.g., most recent) topic floats to the top, see topic 268 Meet at our Apartment.

Secondary frame 262 also includes Conversation Settings, with user-selectable links to Participants & Observers, Identities Allowed, and Participation Rules. The Participants & Observers settings enable a user to define individuals or groups as either participants to the conversation topic or non-participating observers that cannot add content. The Identities Allowed settings enable a user to determine which of several predefined types of participant identities are allowed, e.g., an exclusion of alias and/or anonymous identities. The Participation Rules settings enable the user to define as set of rules that govern participation in and privacy levels of the conversation and/or conversation topic, such as who can join the conversation, who can observe it, and who can see its title and contents.

Selection of the Cover tab 270 causes generation of a display that is controlled only by the convener of the conversation who can add any textual, visual or dynamic (e.g. html) content to that page. Selection of the Calendar tab 274 causes generation of a display of a user calendar, which may show any of a variety of calendar entries related to the conversations of the user, or other user entered entries that relate to the conversation. Selection of the To-dos tab 276 causes generation of a display of a user to do list, which may show any of a variety of entries related to the conversation of the user, or other user entered entries that relate to the conversation.

In either conversation page 150 and 250 of FIGS. 2A and 2B, respectively, the user has the ability to add his own snippet to any topic that is shown. For example, in FIG. 2A a Reply button 212 is provided for each topic. In FIG. 2B a dialog box 264 is provided. Selecting the Reply buttons 212 or dialog box 264 opens up an interface that enables the user to contribute content to the topic.

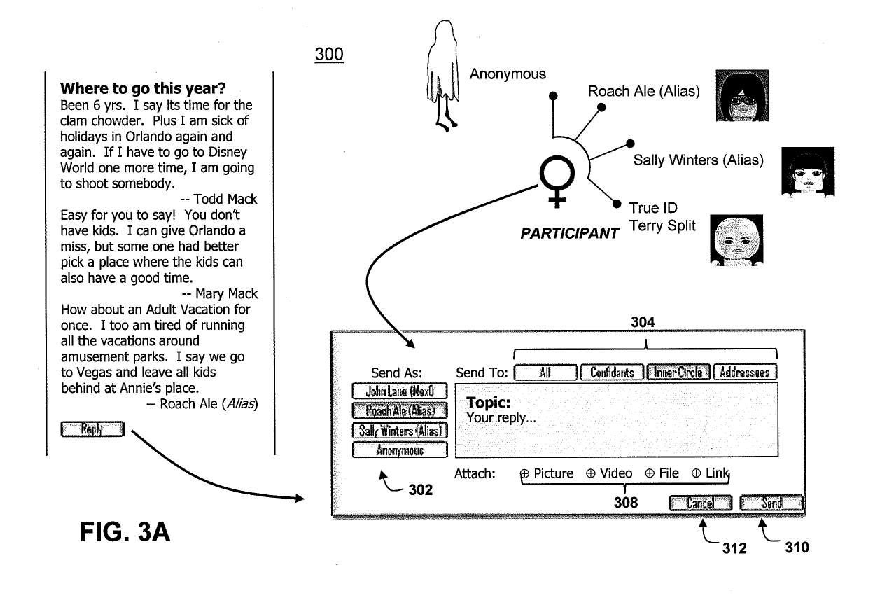

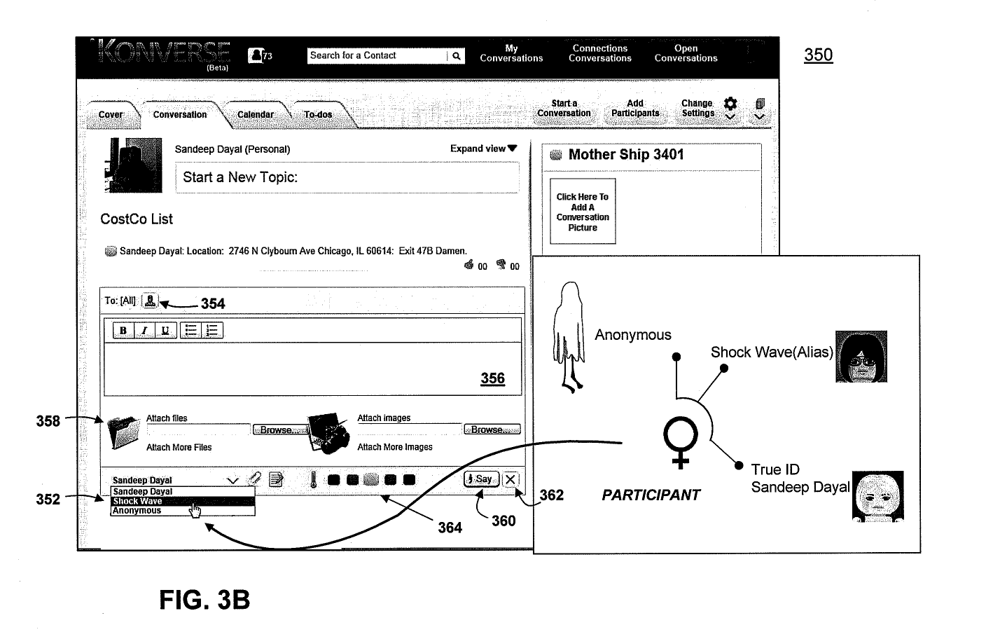

FIG. 3A is an embodiment of a reply page 300 presented on a display by the MUMCP in response to a user selection of the “Reply” button under the topic “Where to go this year?” on the conversation page of FIG. 2A, in accordance with aspects of the present invention. Clicking on Reply allows you to post a reply in the familiar email like fashion.

Each participant can have multiple profiles, including a true identity, one or more aliases, and/or an anonymous profile with which to communicate to others. As is shown in FIG. 3A, an email like interface can be presented in which the user can select addressees and one of its profiles under which to send the message. In this embodiment, the user has four identities: (1) Terry Split, which is the user's actual name; (2) Sally Winters, which is an alias; (3) Roach Ale, which is another alias; and (4) anonymous. The user can select its identity using the buttons in the “Send As” area 302.

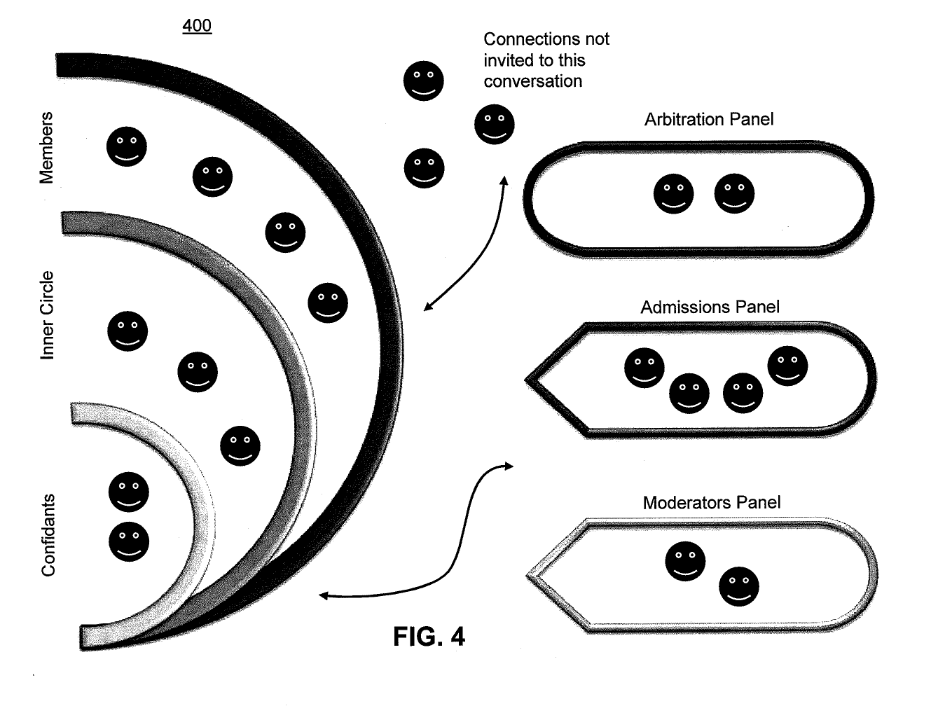

In this embodiment, the user can select addressees, using buttons in the “Send To” area 304. The addressees may be people formally within the conversational group or outsiders. In this embodiment, the buttons include (1) All button; (2) Confidants button; (3) Inner Circle button; and the Addressees (or Members) button. See FIG. 4 for an explanation of these different types of addressees for a participant.

Reply page 300 also includes a text entry box 306 that enables a user to enter its textual content, e.g., by typing or dictating if a speech-to-text program is included. Reply page 300 also includes a set of additional content buttons 308 that, in this embodiment, allow the user to attached pictures (images), video, files, and/or links. Button 310 can also be provided to enable the user to send the reply 310 or cancel the reply 312. Once the reply is sent, it is added to the discussion thread for the topic and visible to the selected participants.

FIG. 3B is another embodiment of a reply page 350 presented on a display by the MUMCP in response to a user selection dialog box 264 on the page of FIG. 2B, in accordance with aspects of the present invention. The replay can be provided, therefore, through a mechanism that resembles a familiar email interface. Reply page 350 includes mechanisms 352 that enable the user to select an identity from among a plurality of identities, as described above. An addressee section 354 allows the user to identify other participants that will receive the reply. Reply page 350 also includes a text entry box 356 that enables a user to enter its textual content, e.g., by typing or dictating if a speech-to-text program is included. Reply page 350 also includes a set of additional content buttons 358 that, in this embodiment, allow the user to attached pictures (images), video, files, and/or links. “Say” button 360 can also be provided to enable the user to send the reply, which could otherwise be cancelled by selecting the “X” button 362. Color cues buttons 364 are also provided that enable the user to distinguish its reply, e.g., as urgent. Once the reply is sent, it is added to the discussion thread for the topic and visible to the selected participants.

FIG. 4 is an embodiment of a notional diagram demonstrating conversation groupings and entities implemented by the MUMCP, in accordance with aspects of the present invention. In FIG. 4, conversation groups are represented with semi-circles defined from the perspective of the sender, and may be different for each member of the group. In various embodiments, each user can organize the participants within each conversation into hierarchical circles such as a confidant's circle, an inner circle and a member circle. A snippet (or reply) may be addressed to any of these circles. A snippet addressed to the confidant's circle will only be seen by the participants defined by the user as confidants, but snippets addressed to the inner circle will be seen by any participant in the inner circle or the confidant's circle. A snippet addressed to the members circle will be seen by all participants.

The MUMCP also allows users to set up separate Admissions/Convener, Moderator and Arbitration panels. Members in the Admissions/Convener Panel decide who can join or observe the conversation. Members in the Moderator Panel maintain a decorum or order in the discussion and may decide which snippets of specific participants to delete, which participants to expel, which snippets to move to different topics for better organization, etc. The Arbitration Panel includes members that offer an expert view or help the participants make a decision by arbitrating/ruling on an issue of interest to participants via an arbitrator poll or other tool.

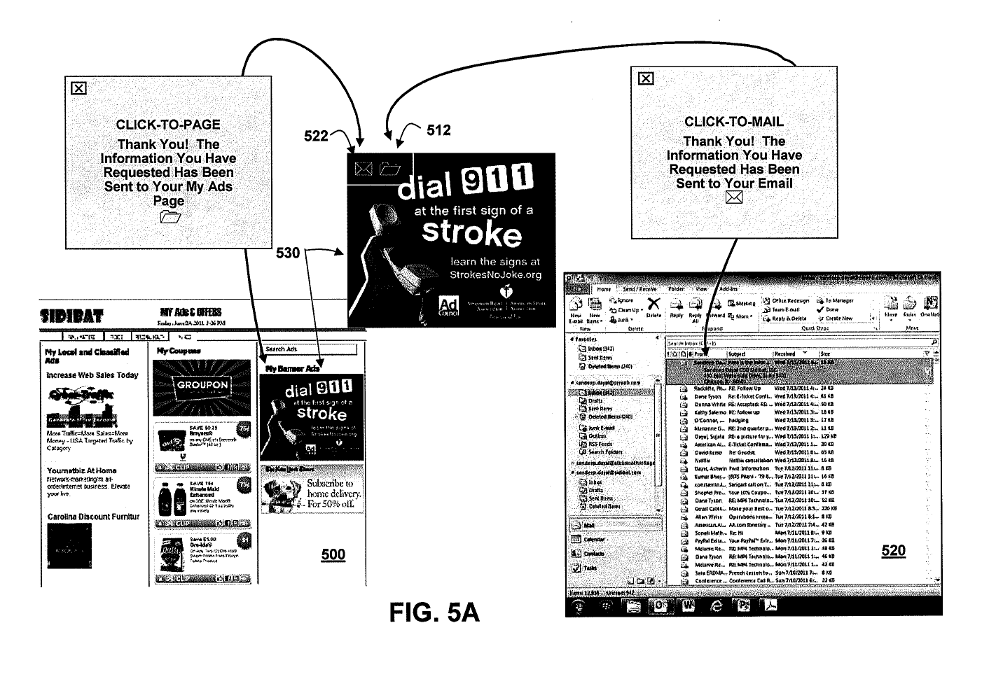

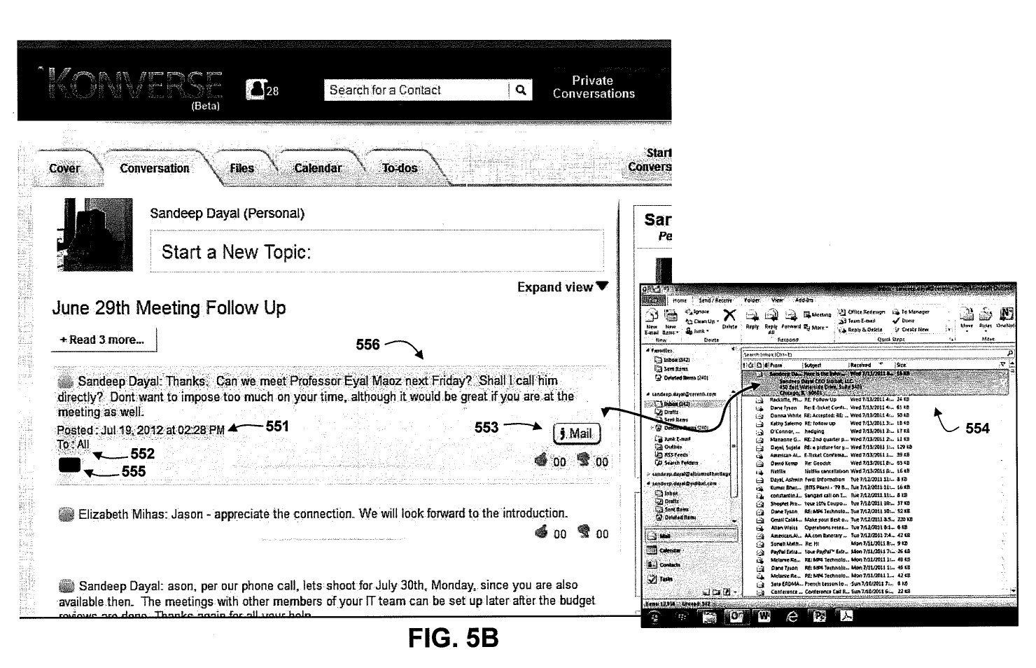

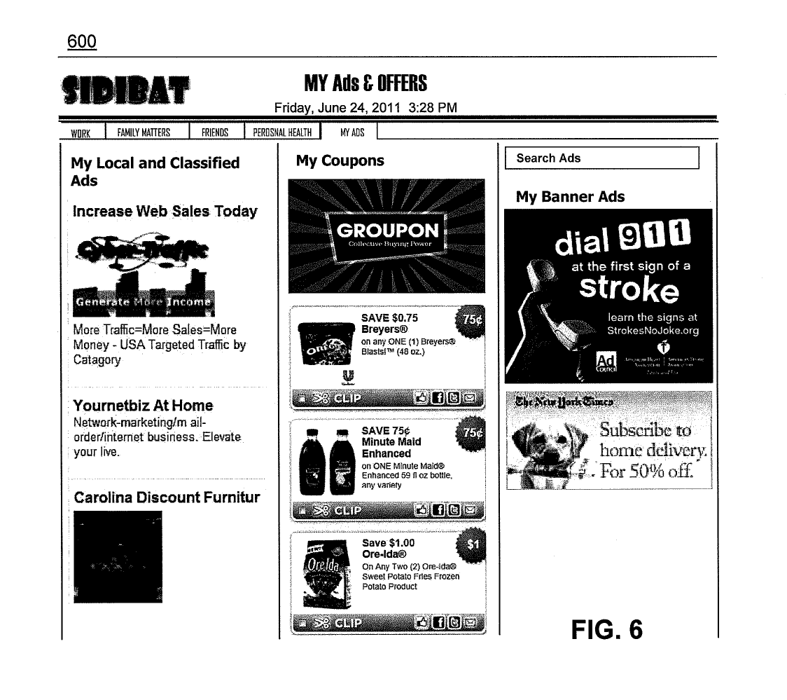

FIG. 5A is an embodiment of a functional flow diagram demonstrating click-to-mail and click-to-page functions implemented by the MUMCP, in accordance with aspects of the present invention. FIG. 5B is an embodiment of a functional flow diagram demonstrating use of the click-to-mail function implemented by the MUMCP, in accordance with aspects of the present invention. And FIG. 6 is an embodiment of an ads page presented on a display by the MUMCP, in accordance with aspects of the present invention.

Conversations hosted by the MUMCP can be further streamlined by allowing a user to not interrupt their conversation flow when they click on an ad (e.g. banner ads). Users can be given the ability to specify that Ads when clicked will result in the system requesting advertising materials from the ad sponsor to be re-directed to designated “My Ads” page 510 on the MUMCP platform or to the user's email 520, as shown in FIGS. 5 and 6. (See also the My Ads tab in FIG. 1A)

For example, in FIG. 5A the ad 530 (also shown in exploded form) includes a folder icon 512 that sends the ad information to the My Ads page 510 of the user and also includes an envelope icon 522 that sends the ad information to the user's email.

My Ads page 600 is shown in FIG. 6, which is similar to the display presented in FIG. 1A, but with the My Ads tab selected. In this embodiment, the My Ads page 600 is presented with 3 columns. The My Ads tab/page will contain personally relevant Ads for the user based on their profile and preferences. All “Click-to-Page” Ads will be transferred to this page—possibly with additional information for user presented here and/or emailed to them. There is a My Local and Classified Ads column, a My Coupons column, and a My Banner Ads column. The determination of which ads go into which columns is made by the category those ads belong in or what type they are, e.g. coupon offers are put in a topic called “Coupons”.

This aspect of the invention can be extended to platforms beyond the MUMCP to any platform that hosts ads on its pages, such as Google and Yahoo type search engines, retail websites, social networks (like Facebook), etc. In other cases, a special area of the Ad will have a special symbol, such that when a user clicks the ad on the symbol, the Ad information will be redirected to email in a “Click-to-Mail” application and to the “My Ads” page 600 in a “Click-To-Page” application. If the users email is unavailable, the system will request the user to provide one.

As another streamlining tool, as shown in FIG. 5B, the MUMCP may by default hide envelope information, such as time and date sent 551, addressed participant and observer list 552, attachments 555, etc. associated with a snippet (reply), to-do or calendar item. By highlighting the snippet 556, to-do or calendar item, a participant or observer may see such information below the snippet or on a separate panel, such as the right panel. Further, a “Click-To-Mail” button 553 thus revealed allows the reader to send highlighted snippets, to-dos, calendar items, to their default email 554 in a single click.

The MUMCP will be a powerful conversational platform and will also allow many other types of special conversations to take place. For example, the MUMCP will allow companies to conduct online Focus Groups and allow experts to offer their advice and services to online consumers. To support these activities, MUMCP will allow users to charge a fee for their participation. For example, physicians participating in an online Focus Group will be able to charge a fee for their participation. The Focus group would be open for a fixed period of time, say 1 day, during which participants could respond to different questions and topics of the conversations as well as to the comments and questions posed by facilitators, other participants and focus group sponsors. In other cases, users (say, experts and advisors) will be able to charge participants a fee for their participation. For example, a blogger or investment adviser may charge participants a fee to allow them to see the content they post in their conversation. In other cases, an expert, such as a Priest, could offer a confidential confession service to a participant for no fee.

To address issues around individuals being obnoxious in conversations, the MUMCP will allow users to rate other user snippets and profiles. These ratings can be combined mathematically into a reputation score that will impact other users view of the rated user. In one version, the reputation metric would be a mathematical combination of the rating given, weighted by the degree of interaction the user has had with that user (proxy for how well they know each other), and the reputation of the rating agent themselves (high ratings by people with high reputation count for more than high ratings by users with poor reputation). The reputation scores could carry consequences. For example, users with a poor reputation may not be allowed into a group.

The MUMCP may also be configured to allow participants to charge a fee for their participation in some groups or to other users that wish to access their posts.

The MUMCP may also be configured to have a social currency or point system to allow users to access certain privileges or trade (buy and sell) information with friends. For example, every user that signs up 50 other friends may be awarded, for example, 100 points or social dollars. A user may sell his blog for 10 points or social dollars or $1 of real currency. These are merely a couple of examples. Users could acquire points based on the number of conversations they start or reply to, or ads they click on. Those points could be translated into coupons, real currency, or be used in some other form.

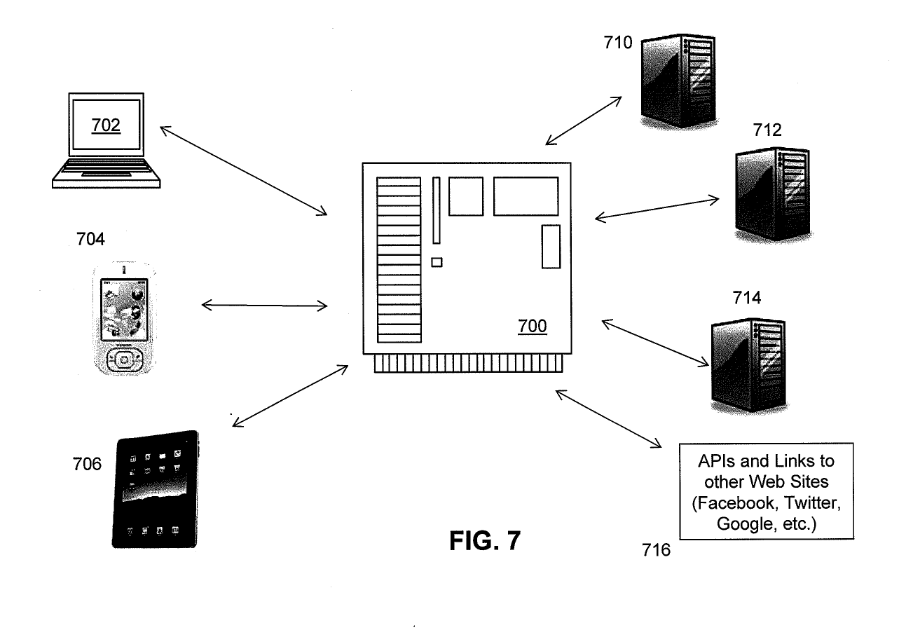

FIG. 7 is a diagram of an architecture comprising an embodiment of a MUMCP platform, in accordance with aspects of the present invention. This figure demonstrates, for this embodiment, overall relationships between the MUMCP, its users (participants), and providers. The present invention is not limited to these relationships.

The MUMCP system 700 comprises one or more computer processors executing MUMCP program code to enable the functions described herein, or otherwise inherent. The MUMCP system 700 may be a centrally located system, or distributed across a network, such as the world wide web. The MUMCP system 700 may utilize “cloud” servers and/ or computer storage 710.

The MUMCP system 700 may be configured to interact and communicate with participants using any of a plurality of different types of computing devices, such as personal computers 702, smart phones 704, tablets 706 and the like. The communication could be over any of a variety of types of known or hereafter developed networks.

The MUMCP system 700 may be configured to interact and communicate with various cloud servers for applications and storage 710 and ad servers and sources 712, via one or more networks. The MUMCP system 700 may also be configured to interact and communicate with various payment servers and systems 714, via one or more networks, e.g., for the payment of fees for membership, ads, and/or purchasing of products and services in association with the MUMCP system 700. The MUMCP system 700 may also be configured to interact and communicate with various social networking servers and systems 716, via one or more networks, such as email systems, Facebook, Twitter, LinkedIn, and the like.

Starting a New Conversation

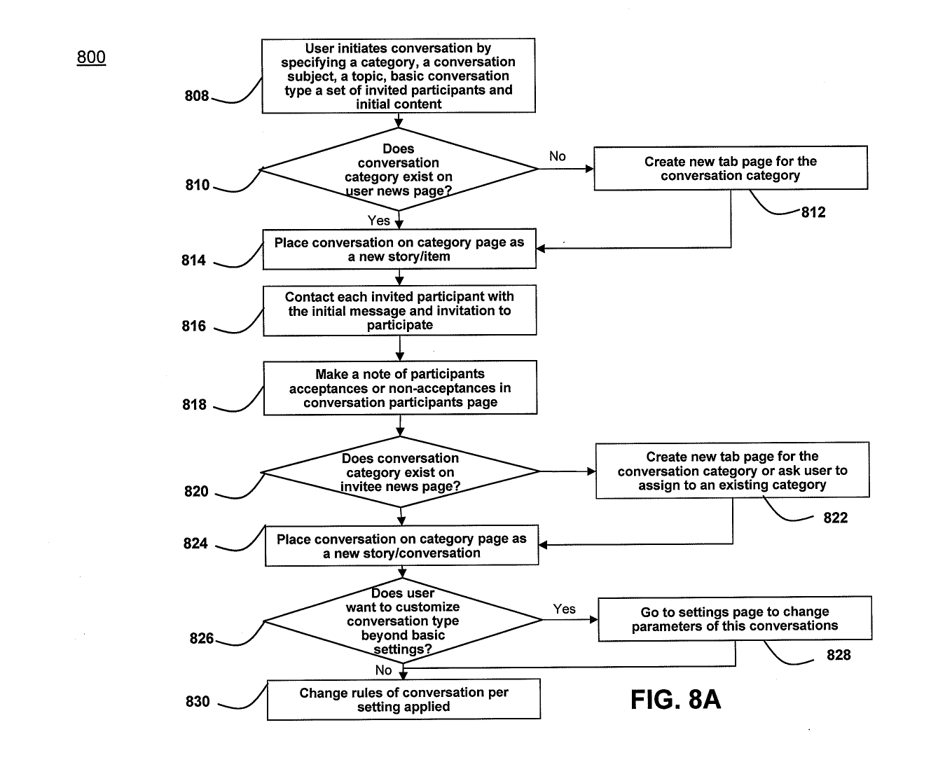

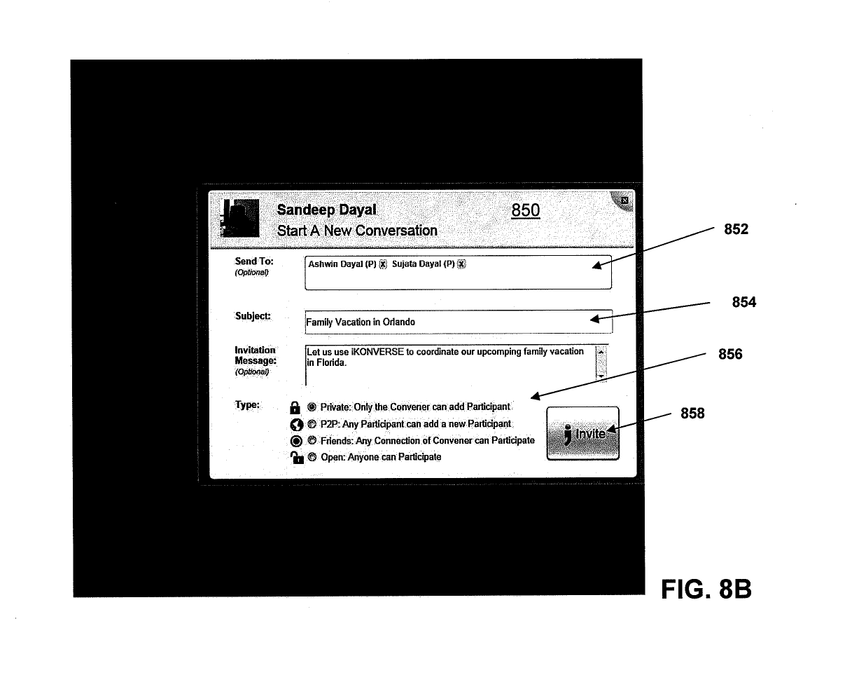

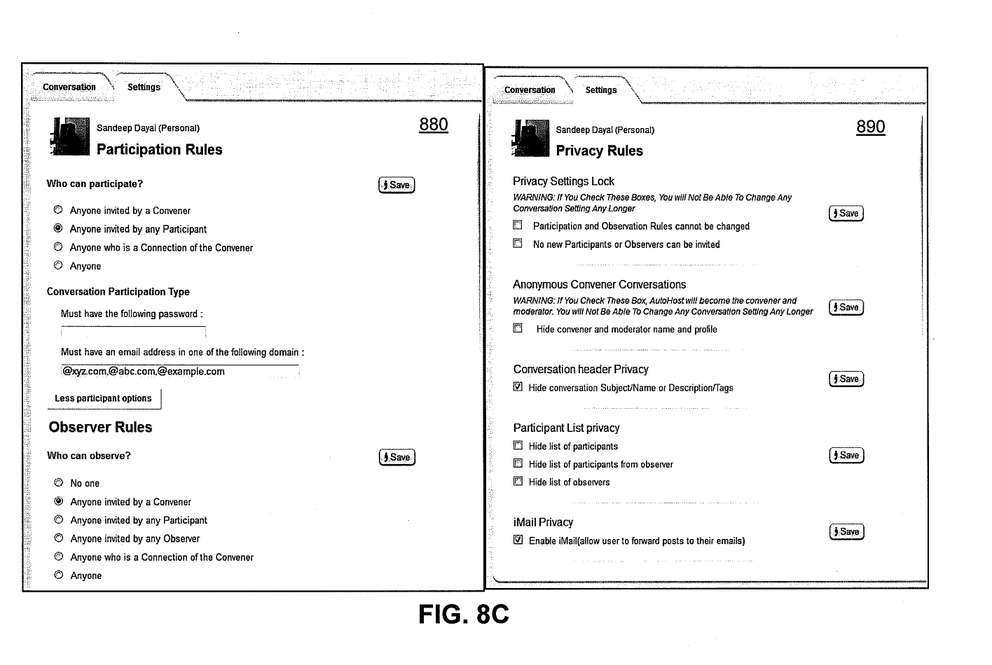

FIG. 8A is a flow diagram of an embodiment of a method 800 of conversation setup using the MUMCP platform, in accordance with aspects of the present invention. FIG. 8B is an embodiment of a display screen 850 useful for explaining the method of starting a new conversation using the MUMCP platform of FIG. 7, in accordance with aspects of the present invention. And FIG. 8C is an embodiment of display screens of different Settings pages useful for a method of conversation setup using the MUMCP of FIG. 7, in accordance with aspects of the present invention.

FIG. 8A shows one embodiment of a method 800 by which a new conversation can be started using the MUMCP system 700. A user initiates a conversation by specifying a category, conversation subject, a topic, a set of invited participants and initial contents, in step 808. An example of a method of doing this will be described with respect to FIG. 8B. Referring to FIG. 8B, the Start A New Conversation display 850 shown is presented in response to a user selecting the “Start a Conversation” button present in or near the header region of a display screen, e.g., see FIGS. 2A and 2B. The user can select participants for the conversation by name or from pre-defined groups, in the Send To box 852 in FIG. 8B. The user can enter a category name in Subject box 854 gives, e.g., “Family Vacation in Orlando.” The initial message content can be input in the “Invitation Message” box 856, e.g., a message that says something like “Let us use iKONVERSE to coordinate our upcoming family vacation to Florida.,” as is in FIG. 8B. The user can further choose a conversation Type. In this embodiment, the conversation Types are: (1) Private, where only the conversation initiator/ creator (or convener) can add participants; (2) P2P (Participant-to-Participant), where any participant can add a new participant; (3) Friends, where any connection of the convener can add a participant; and (4) Open, where any participant can add a participant. In other embodiments, other types could be defined, and the present types could be redefined, or a combination thereof. Once completed, the user selects the “invite” button 858 and the conversation is created and the invitation is sent to the designated participants. Thereafter, on the Conversations page, the user can enter a new topic and content (e.g., a snippet). (see, e.g., FIG. 2B)

In method 800, the following steps 810 through 824 are accomplished automatically by the MUMCP system 700, after the convener selects the “invite” button on in FIG. 8B. Returning to FIG. 8A, in step 810, if the conversation category does not exist already, it is created as new tab on the user's page in step 812. The conversation is then placed in the user's category in step 814. In step 816 the message is delivered to each invited participant. In step 818, the participants that accept or reject the request for participation are noted on the conversation metrics page.

Next, in step 820, the MUMCP system 700 checks to see if the conversation category exists on the invitees' conversation hub. If yes, it places the conversation in the existing category and if not, in step 822, it creates a new category or asks the invitee to assign the conversation to an existing category. For example, if the invitee does not have a category called “Family”, but does have a category called “Family Matters”, he can assign the conversation to his tab called “Family Matters”. In step 824, the MUMCP system 700 places the conversation on the assigned category page.

In step 826, the user can elect to optionally modify the conversation settings. By default the conversation may be “closed” to allow only the invitees to participate, and have only the initiator of the conversation as the sole person responsible for accepting new group members. However, all of those elements could be changed in step 828 on a conversation settings page.

Note that the display of FIG. 2B shows Conversation Settings with user-selectable options. FIG. 8C shows options for “Participation Rules” 880 and “Privacy Rules” 890 that the convener of the conversation may set, as examples. The options for conversation settings could include Participants and Observers, which allow the convener to see the conversation participants and observers, the “Type” for each, and to selectively hide a list of participants and/or a list of observers from others. The options for conversation settings could also include options for allowing the convener to select Identities Allowed into the conversation, e.g., one or more of the predefined identities Personal, Business, Alternate, and Anonymous. The options for conversation settings could include Participation Rules (see FIG. 8C), which allow the convener to select among options of what type(s) of users can participate and what type(s) can observe. The options for conversation settings could include Privacy Rules (see FIG. 8C), which allow the convener to select among options of privacy settings for the conversation. The options for conversation settings could include Email Notification, which allows the convener to select among options for the frequency of email notifications to participants and observers for the conversation. The options for conversation settings could include a Delete or Leave option, which allows the convener to select among options for deleting or leaving the conversation. And the options for conversation settings could include an About Conversation option, which allows the convener to re-enter the subject and description (or initial message) and to add tags to the conversation; the convener may also choose whether or not to hide the subject/name or description/tags for the conversation.

In step 830, the MUMCP system changes the rules of the conversation per the new settings choices.

Participating in an Existing Conversation

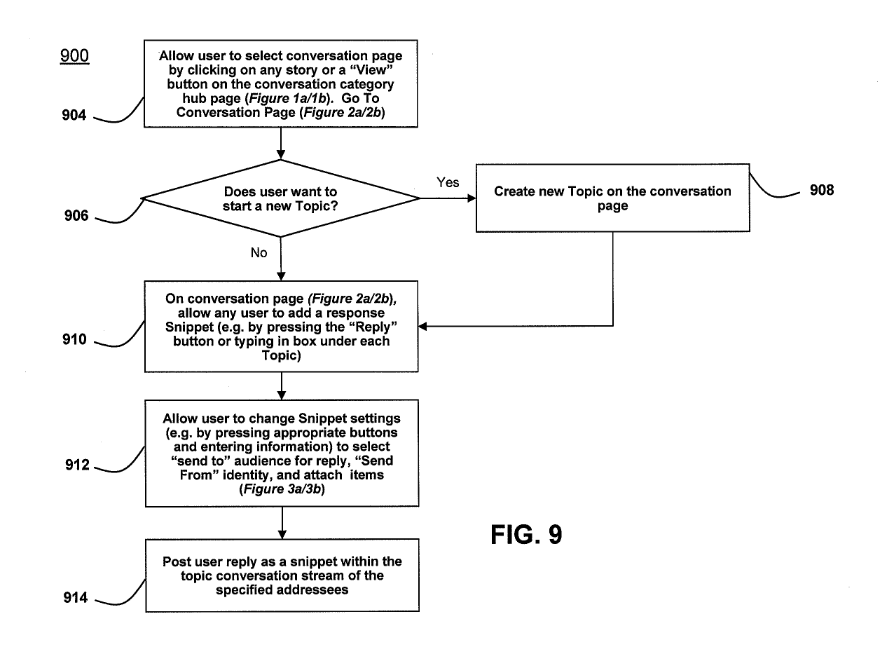

FIG. 9 is a flow diagram of an embodiment of a method 900 of conversation participation using the MUMCP system 700, in accordance with aspects of the present invention. For example, FIG. 9 shows how a user of the MUMCP system 700 can participate in an existing conversation.

To participate, the user first selects the conversation page in step 904 from its conversation category hub page (e.g., see also FIGS. 1A and 1B), and opens that conversation page (e.g., see also FIGS. 2A and 2B). Next, in step 906, the user decides whether he wants to create a new topic for his response, or add his response to an existing topic. In step 908, the user has the option to first create a new topic.

In step 910, the user is able to click “Reply” (or click into a reply dialog box) to any conversation under any existing topic or new topic created in step 908. (e.g., see also FIGS. 2A and 2B) Selecting reply opens up a reply interface in step 912 and allows a user to enter a “snippet” response (i.e., a reply). Further, the user is able to select various other parameters associated with the reply, such as specifying who can view the reply, which sender profile (e.g. true identity, alias or anonymous identity) is exhibited in the reply, as well as other parameters, such as behavior cues (color codes or “smiley” face icons) or level of urgency, and so on. In step 914, the MUMCP system 700 posts the response snippet in the conversation stream of the specified addressees.

Bubble-Up, Newspaper Sort Conversation Flow (BUNSCF)

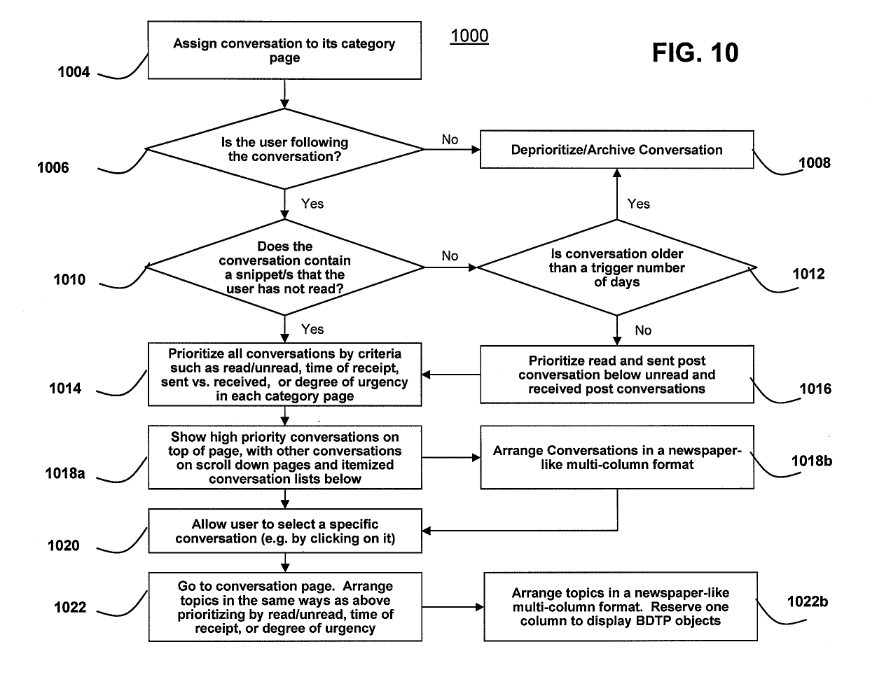

FIG. 10 is a flow diagram of an embodiment of a method 1000 of bubble-up, newspaper sort conversation using the MUMCP platform, in accordance with aspects of the present invention. This method 1000 of the MUMCP system 700 governs how conversational information is presented on the platform, in the preferred embodiment.

In step 1004, a given conversation is assigned to its conversational category per algorithms described in FIG. 8A. A user may have many conversations in a single category. For example, a user may be having 5-10 conversations related to the “Family” category, such as, “Summer Vacation”, “Daughter's Career Choice”, “Cousin's Request for Loan”, “Babysitter Pay”, and so on. (e.g., see FIGS. 1A and 1B)

All conversations that the user is invited to, is or was a part of, within a category, are analyzed in step 1006, to check if the user is following them and is, thus, interested in seeing updates. It is noted, that the user may also elect to follow some conversations selectively, by specifying which other user updates he is interested in. For example, in the case of a blog hosted on the MUMCP system 700, a participating user may only want to see updates and comments from the blog author but not from the participants. In the embodiment of FIG. 1b, clicking the “Zzz” button 204 (see FIG. 1B) allows a user to “un-follow” a conversation or put it to sleep.

If the user is not following the conversation, the MUMCP system 700 archives the conversation in step 1008 and stores it in a list which the user can return to and re-activate or re-follow if the user changes its mind later. In step 1010, the MUMCP system 700 checks if the followed conversation contains a snippet that is a priority for the user. For example, it may contain a snippet that the user has not read, or is marked urgent, or is very recent, etc. If none of those conditions are met, in step 1012, the MUMCP system 700 checks to see if the conversation is getting “stale” and not having any activity. If so, it archives the conversation as in step 1008. Else, in step 1016, it prioritizes the snippet below other snippets that were prioritized in step 1010.

In step 1014, the MUMCP system 700 prioritizes all snippets and in step 1018a, “bubbles up” the highest priority conversations to the top. This has the effect of populating the conversation category pages at the top with conversations that are the most important or ones that the user has not read. Other conversations are towards the bottom of the page which also the user can scroll down to. Within each conversation, the snippet shown on the conversation category page is the priority snippet. Further, in step 1018b, multiple conversations on the conversation category page are arranged in a newspaper like multi-column format (e.g., see FIGS. 1A and 1B) so that the user has visibility to multiple, priority conversations and snippets simultaneously. As before, a user can then select any conversation by clicking on it in step 1020.

In step 1022a (e.g., see FIGS. 2A and 2B), the conversation page is also populated in a bubble-up, newspaper sort conversation flow (BUNSCF). In this case, a conversation can have multiple topics. For example, the “Family Vacation” conversation has multiple topics such as “Where to go?”, “Where to stay?”, “What to budget?”, “Who to invite” etc. Once again the snippets within each topic are prioritized, and topics with higher priority snippets bubble up to the top. Multiple topics are arranged side-by-side in newspaper like multi column format.

In step 1022b, in addition to topics, other BDTP objects, including for example (News) Bulletins, (Key) Dates, Polls, etc. are listed in separate column. Once again, objects with recent or priority activity are bubbled up to the top of their column.

Click-To-Mail and Click-To-Page Ad Flow

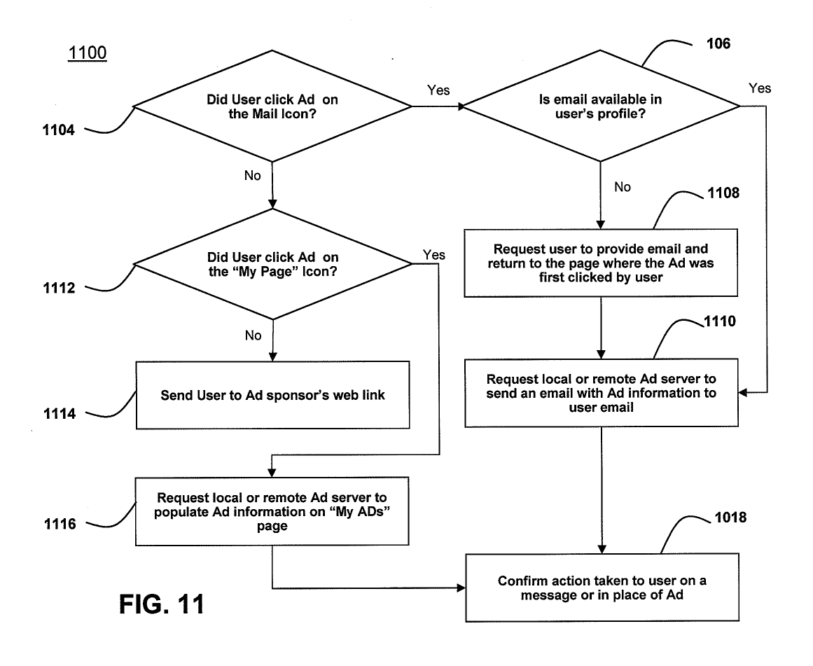

FIG. 11 is a flow diagram of an embodiment of a method 1100 of click-to-mail and click-to page ads flow using the MUMCP, in accordance with aspects of the present invention. This feature of the MUMCP system 700 is shown and described with respect to FIGS. 5A, 5B, 6 and 11. As shown in FIG. 5A, in one version of this, a banner ad will have special icons indicating an option to email information or to send it to the My Ads page on the MUMCP system 700. FIG. 11 shows the corresponding method 1100.

In step 1104, the MUMCP system 700 checks to see if the user clicked on the “Mail” icon. If yes, then in step 1106, the MUMCP system 700 checks to see if it has the user's email stored in the user's profile. If not, then in step 1108, it prompts the user to enter its email without causing the user to leave the page that is it using or returning the user to the page after the email is obtained.

In step 1110, a local or remote Ad server then sends the requested Ad information by email to the user using the email provided in step 1108 or the one already on the user's profile.

If in step 1104 the user had not clicked on the “Mail” icon, the MUMCP system 700 checks if instead the user had clicked on the “My Page” icon in step 1112. If not, then in step 1114, the MUMCP system 700 redirects the user to the Ad sponsors website, as is normally the case with banner Ads. If on the other hand, the user did click the “My Page” icon, then in step 1116 the Ad information is populated on the “My Ads” page of the user as shown in FIGS. 5 and 6.

After steps 1110 and 1116, the user is shown a message confirming the action taken in step 1118.

While the foregoing has described what are considered to be the best mode and/or other preferred embodiments, it is understood that various modifications can be made therein and that the invention or inventions may be implemented in various forms and embodiments, and that they may be applied in numerous applications, only some of which have been described herein. It is intended by the following claims to claim that which is literally described and all equivalents thereto, including all modifications and variations that fall within the scope of each claim.

What is claimed is:

1. A multi-user, universal multi conversation computer platform, comprising:
a computer system accessible via one or more networks by a plurality of different types of electronic devices and systems; and
a computer program product hosted on the computer system, and executable to provide a graphical user interface (GUI) via a user device, the GUI comprising a plurality of computer screens delivering a set of user-based functions, including:
enabling a user to define a plurality of conversation categories;
enabling the user to define different user identities for use when conversing in different conversation categories;
enabling the user to define different conversation groups of users for each conversation category;
organizing the conversation categories in independent display regions on a conversation page;
displaying conversation activity into respective independent display regions; and
enabling the user to communicate with other users within a conversation category using a user defined identity.
